(19) United States
(12) Patent Application Publication
(10) Pub. No.: US 2026/0169946 A1
(43) Pub. Date: Jun. 18, 2026

(54) CONFIGURABLE INPUT/OUTPUT DRIVER CIRCUITRY FOR CONTROLLER AND NAND COMMUNICATION IN A DATA STORAGE DEVICE

(71) Applicant: Sandisk Technologies, Inc., Milpitas, CA (US)

(72) Inventors: SUKNEET BASUTA, San Jose, CA (US); SHIV HARIT MATHUR, Bangalore (IN); ROHIT NADGAUDA, San Jose, CA (US); DMITRY VAYSMAN, San Jose, CA (US); HANAN BORUKHOV, San Jose, CA (US)

(73) Assignee: Sandisk Technologies, Inc., Milpitas, CA (US)

(21) Appl. No.: 18/983,213

(22) Filed: Dec. 16, 2024

(51) Int. Cl. G06F 13/40; G06F 13/16

(52) U.S. Cl. CPC G06F 13/4072; G06F 13/16

(57) ABSTRACT

A storage device may establish a connection with a receiver in a memory device that is booted up in a Center Tapped Termination (CTT) mode. A toggle mode (TM) link may connect the storage device to the memory device. The storage device may include a Low Tapped Termination (LTT) input/output (IO) driver including a NMOS pull-up, a configurable PMOS pull-up to pull up an output high voltage (VOH), and an unterminated channel. When the storage device is booted in the LTT mode, a controller in the storage device may enable the PMOS pull-up to cause the controller to operate in the CTT mode and communicate with the memory device booted in the CTT mode. Once communication is established, the controller may direct the memory device to switch to the LTT mode and the controller may disable the PMOS pull-up.

### BACKGROUND OF THE INVENTION

A storage device may be communicatively coupled to a non-volatile memory including, for example, a NAND flash memory device on which the storage device may store data received from a host. A toggle mode (TM) link may connect a controller on the storage device to a receiver on the memory device. The performance between the memory device and the storage device may increase with newer generations of the TM link to obtain higher throughput between the memory device and the storage device. For example, a first-generation TM link (TM1) connecting the storage device to the memory device may operate in the 800-megahertz (MHz) frequency range while the fifth generation TM link (TM5) may operate in the gigahertz (GHz) frequency range.

When the memory device uses a TM link in the first through fourth generations (i.e., a TM1-TM4 link), the memory device may operate using center tapped termination (CTT). When the memory device uses a TM5 link, the memory device may operate using CTT and low tapped termination (LTT). The memory device may be booted up in CTT when it uses a TM link in the first through fifth generations (i.e., a TM1-TM5 link). For a device to communicate with the receiver in the memory device, a CTT driver in the device may have a PMOS pullup that may allow an output high voltage (VOH) to reach and terminate at a center reference (Vref1). Vref1 may be a supply voltage or output stage logic power voltage (VCCQ) divided by two. To increase the frequency with a given current when using CTT, the voltage may be decreased. However, in CTT, termination values on a channel between the device and the receiver may not be changed because changes in the termination values may lead to more reflection on the channel.

LTT may be used to decrease the voltage, wherein in LTT instead of terminating from the center reference (i.e., Vref1) as is done in CTT, the termination is from ground. As such, with LTT, a signal may terminate at a reference (Vref2) that may be closer to 0 as a result of the lower output voltage. To get the same current from a PMOS as an NMOS, the size of the PMOS may be about two and a half times or more than that of the NMOS. Since the signal in LTT may be between 0 and VCCQ, a PMOS is not needed in the input/output (IO) drivers in LTT. Instead, the PMOS may be replaced with a NMOS.

The storage device may be booted up in LTT while, as noted, the memory device may be booted up in CTT. When the controller in the storage device booted up in LTT sends a signal to a receiver in the memory device booted up in CTT, the controller may send the signal on Vref2 while the receiver may be expecting a signal on Vref1. The receiver in the memory device may therefore not detect the data or clock signals sent from the controller in the storage device on Vref2.

To enable the controller in the storage device and the receiver in the memory device to communicate when the storage device and the memory device are booted up, a current approach may set up the controller in the storage device to operate in CTT and LTT. With the controller in the storage device set to operate in CTT and LTT, the storage device and the memory device may be booted up in CTT. With this approach, the IO drivers in the controller may include a large size PMOS and NMOS. Vref1 between the controller and receiver may include a first switch and Vref2 between the controller and receiver may include a second switch to enable the controller and receiver to switch from Vref1 to Vref2. As part of a boot up sequence when a TM5 link is used to connect the storage device and memory device, the storage device and memory device may boot up in CTT and the controller in the storage device may turn on the PMOS to send a signal on Vref1. The memory device may receive the signal on Vref1 and, as part of the boot up sequence, the storage device and memory device may communicate to move to LTT. In LTT, the controller may use the NMOS to send the signal on Vref2, wherein the memory device may switch from Vref1 to Vref2 to receive signals from the storage device. As CTT requires a large PMOS, the cap on the NMOS may be large and this approach may require additional area and power and increase the output capacitance, which may diminish the benefits of using LTT.

### SUMMARY OF THE INVENTION

In some implementations, the storage device may establish a connection with a receiver in a memory device that is booted up in a Center Tapped Termination (CTT) mode. The storage device may include an access point to connect the storage device with a toggle mode (TM) link to communicatively couple the storage device to the memory device. The storage device may include a Low Tapped Termination (LTT) input/output (IO) driver including a NMOS pull-up, a configurable PMOS pull-up to pull up an output high voltage (VOH), and an unterminated channel. A controller in the storage device may enable the PMOS pull-up to cause the controller to operate in the CTT mode and communicate with the memory device booted in the CTT mode when the storage device is booted in the LTT mode. The controller may also cause the memory device to switch to the LTT mode and communicate with the memory device in the LTT mode.

In some implementations, a method is provided on a storage device for establishing a connection with a receiver in a memory device that is booted up in a Center Tapped Termination (CTT) mode. The method includes booting up the storage device in a Low Tapped Termination (LTT) mode and enabling a configurable PMOS pull-up in a LTT input/output (IO) driver to pull up an output high voltage (VOH). The method also includes sending a pulled-up signal to the memory device on a CTT reference and directing the memory device to switch to a LTT mode. The method further includes switching to the LTT mode, disabling the PMOS pull-up; and communicating with the memory device in the LTT mode.

In some implementations, a storage device may establish a connection with a receiver in a memory device that is booted up in a Center Tapped Termination (CTT) mode. The storage device includes a Low Tapped Termination (LTT) input/output (IO) driver including a stack of NMOS, a configurable PMOS high-resistance pull-up resistor to pull up an output high voltage (VOH), and an unterminated channel. A controller in the storage device may enable the PMOS high-resistance pull-up resistor to cause the controller to operate in the CTT mode and communicate with the memory device booted in the CTT mode when the storage device is booted in the LTT mode. The controller may also cause the memory device to switch to the LTT mode and communicate with the memory device in the LTT mode.

### BRIEF DESCRIPTION OF THE DRAWINGS

FIG. 1 is a schematic block diagram of an example system in accordance with some implementations.

FIG. 2 is an example schematic diagram showing drivers in a storage device wherein signals may be sent between the storage device and a memory device using center tap termination (CTT) or low tap termination (LTT).

FIG. 3 is an example schematic diagram showing a driver in the storage device to cause the storage device to operate in CTT and LTT in accordance with some implementations.

FIG. 4 is another example schematic diagram showing a driver in the storage device to cause the storage device to operate in CTT and LTT in accordance with some implementations.

FIG. 5 is an example diagram showing how a driver in a storage device may cause the storage device to operate in CTT and LTT in accordance with some implementations.

FIG. 6 is an example flow diagram for enabling a storage device which is booted up in LTT to communicate with a memory device which is booted up in CTT in accordance with some implementations.

FIG. 7 is a block diagram of an example environment in which systems and/or methods described herein are implemented.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

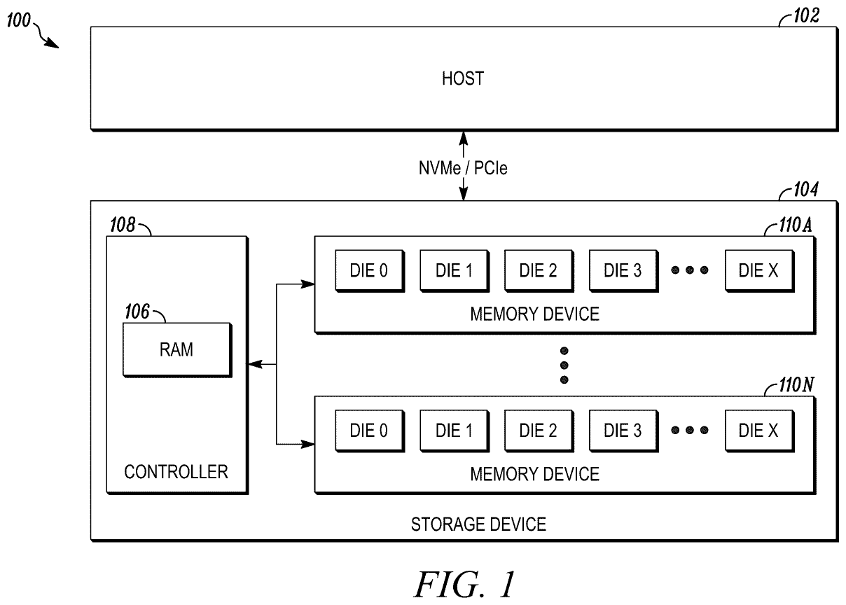

FIG. 1 is a schematic block diagram of an example system in accordance with some implementations. System 100 may include a host 102 and a storage device 104 that may be in the same physical location as components on a single computing device or on different computing devices that are communicatively coupled. Storage device 104 may communicate with host 102 via a Non-Volatile Memory Express (NVMe) protocol over a peripheral component interconnect express (PCIe) interface, and the like. Host 102 may include additional components (not shown in this figure for the sake of simplicity).

Storage device 104 may include a random-access memory (RAM) 106, a controller 108, and one or more non-volatile memory devices 110a-110n (referred to herein as the memory device(s) 110). Storage device 104 may be, for example, a solid-state drive (SSD). RAM 106 may, for example, static RAM (SRAM) or dynamic RAM (DRAM) that be used to store information used on storage device 104.

Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may monitor memory device 110 and may execute garbage collection and other relocation functions per internal relocation algorithms to refresh, recycle, and/or relocate the data on memory device 110.

Memory device 110 may be flash based. For example, memory device 110 may be a NAND or NOR flash memory that may be used for storing host and control data over the operational life of memory device 110. Memory device 110 may include multiple dies (for example, DIE 0-DIE X) for storing the data. Memory device 110 may include a receiver (not shown) to receive information sent from storage device 104. Memory device 110 may be included in storage device 104 or may be otherwise communicatively coupled to storage device 104.

A toggle mode (TM) link may be used to communicatively couple storage device 104 to memory device 110. As such, both storage device 104 and memory device 110 may include access points for connecting with the TM link. Depending on the generation of the TM link, the TM link may support Center Tapped Termination (CTT) (also known as Stub Series Terminated Logic (SSTL)) and Low Tapped Termination (LTT) (also known as Low Voltage Swing Terminated Logic (LVSTL)). For example, the first-fourth generations of the TM link (i.e., TM1-TM4) may support CTT, and the fifth generation of the TM link (i.e., TM5) may support CTT and LTT.

When memory device 110 is booted up, memory device 110 may be booted up in a CTT mode, even when the TM5 link is used to connect controller 108 to the receiver in memory device 110. The TM link may have data lines (DQ), clock lines (DQS), and read-enabled lines (RE). Controller 108 may also use multiple pins to communicate with memory device 110. For example, controller 108 may use a chip enable (CE) pin to control/activate memory device 110, an address latch enable (ALE) pin to send an address to memory device 110, a command latch enable (CLE) pin to send a command to memory device 110, and a write enable (WE) pin to send data to memory device 110.

Storage device 104 may be booted up in a LTT mode and when storage device is booted up in the LTT mode and memory device 110 is booted up in the CTT mode, controller 108 may use LTT input/output (IO) drivers in storage device 104 to send signals to memory device 110. The LTT IO drivers may include NMOS pull-up which may create a voltage (Vt) drop on the maximum output high voltage (VOH) so that the VOH may not reach a supply voltage/output stage logic power voltage (VCCQ). Though disabling the receiver termination may allow the voltage at the receiver to reach a higher value over time since there is no low resistance path to ground (GND), it may take a long time for the VOH to get high enough to clear a receiver mask (RX mask) across all corners. There may need to be margins from the top of the RX mask to the VOH. Therefore, even when unterminated, the LTT drivers may not pull up VOH enough across all corners to reliably write a ‘1’.

The LTT IO drivers may also include a configurable PMOS high-resistance pull-up resistor to pull up the VOH. The PMOS in the PMOS high-resistance pull-up resistor may be of a relatively small size. The resistance on a channel may be high enough to allow for a pull-up resistor (Rpu) and a pull-down resistor (Rpd) to set appropriate logic levels on the channel, but low enough to help increase the VOH. The channel may be unterminated as the weak pull-up may not be strong enough to compensate for the termination.

As such, when memory device 110 is booted up in the CTT mode and storage device 104 is booted up in a LTT mode, controller 108 may enable the PMOS high-resistance pull-up resistor in the LTT IO drivers to enable controller 108 and a receiver in memory device 110 to operate in the CTT mode. As part of a boot up sequence, controller 108 may send a signal to the receiver such that the receiver may pick up the signal on Vref1. Controller 108 may use the signal to direct memory device 110 to move to the LTT mode. When memory device 110 moves the LTT mode, controller 108 may disable the PMOS high-resistance pull-up resistor in the LTT IO drivers as both storage device 104 and memory device 110 may be in the LTT mode. Using the PMOS high-resistance pull-up resistor may not add much capacitance.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

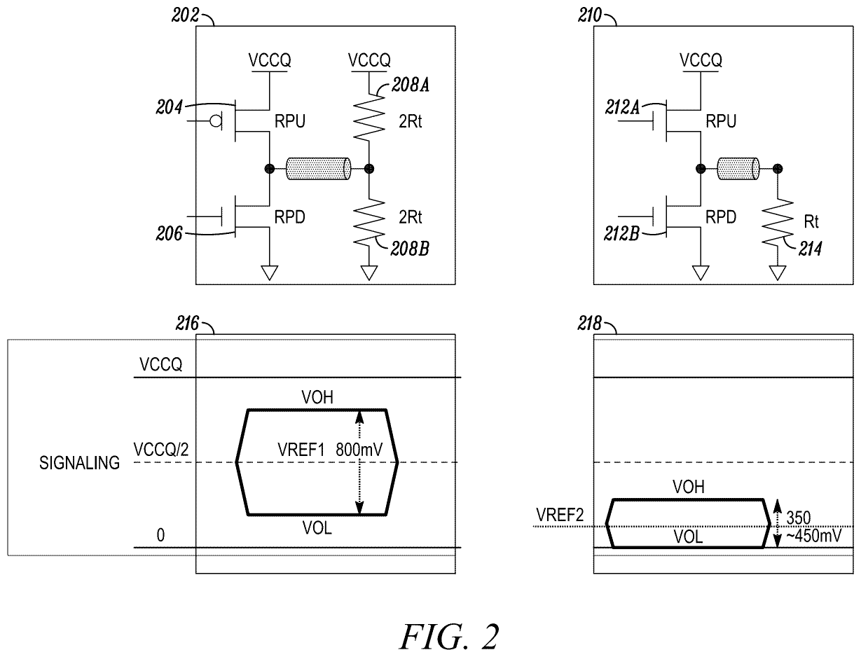

FIG. 2 is an example schematic diagram showing drivers in a storage device wherein signals may be sent between the storage device and a memory device using center tap termination (CTT) or low tap termination (LTT). Driver 202 may be a CTT driver that may include PMOS 204, NMOS 206, supply voltage (VCCQ), and resistors 208a and 208b to terminate a signal. When a signal is sent with driver 202, the signal may ride on a reference (Vref1), that is VCCQ divided by 2, as shown in 216. VOH and VOL are output voltage thresholds that may represent high and low voltage levels. Driver 202 may be used in the CTT mode.

Driver 210 may be a LTT driver that may include NMOS 212a and 212b, supply voltage (VCCQ), and resistors 214 to terminate a signal. When a signal is sent with driver 210, the signal may ride on a reference (Vref2), that is may be close to 0, as shown in 218. Driver 202 may be used in LTT.

If storage device is booted up in the LTT mode, when a signal is sent from storage device 104 using driver 210, the signal may be sent on Vref2. As noted, memory device 110 may be booted up in the CTT mode and when memory device is in CTT mode the receiver in memory device 110 may only receive a signal sent on Vref1. As such, if storage device 104 is booted up in the LTT mode and memory device 110 is booted up in the CTT mode, and if storage device uses driver 210 to send a signal to memory device 110 the receiver in memory device 110 may not receive the signal sent from controller 108. As indicated above FIG. 2 is provided as an example. Other examples may differ from what is described in FIG. 2.

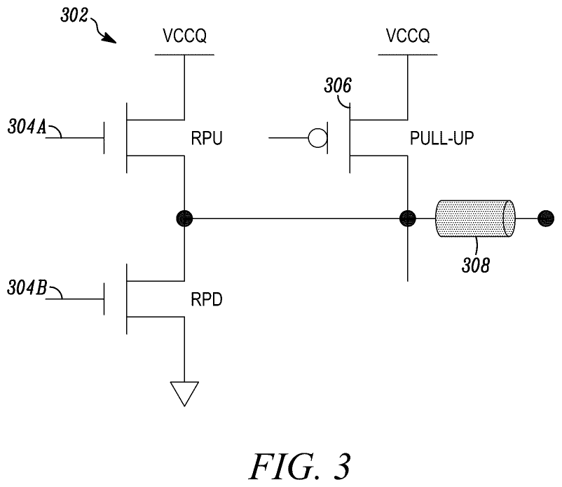

FIG. 3 is an example schematic diagram showing a LTT driver in a storage device to cause the storage device to operate in CTT and LTT in accordance with some implementations. Driver 302 may be, for example, a 37.5/75 ohms or 50/100 ohms driver that may include NMOS 304a and 304b and a configurable PMOS 306 to pull up a VOH. PMOS 306 may be multiple times smaller than a PMOS used in CTT but strong enough to pull up a signal sent from controller 108 to a receiver in memory device 110 such that the signal may ride on Vref1. PMOS 306 may be, for example, two to ten kilo ohms. A resistance on channel 308 may be high enough to allow for the Rpu and Rpd to set appropriate logic levels on the channel, but low enough to help with the VOH. Channel 308 may be unterminated as the weak pull-up may not be strong enough to compensate for termination. PMOS 306 may be enabled while memory device 110 is in CTT and may be disabled with storage device 104 and memory device are in LTT. As indicated above FIG. 3 is provided as an example. Other examples may differ from what is described in FIG. 3.

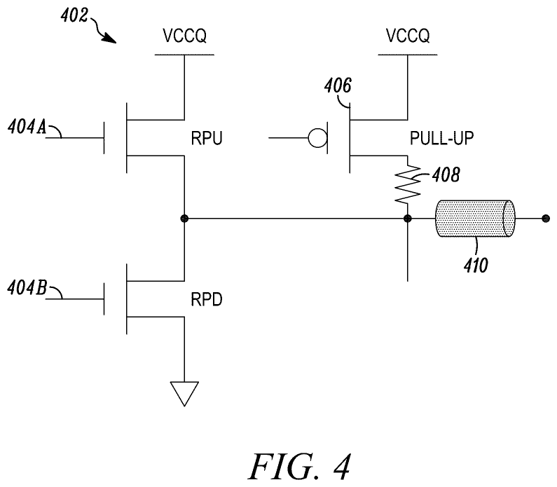

FIG. 4 is another example schematic diagram showing a LTT driver in a storage device to cause the storage device to operate in CTT and LTT in accordance with some implementations. Driver 402 may be, for example, a 37.5/75 ohms or 50/100 ohms driver that may include NMOS 404a and 404b and a configurable PMOS 406 to pull up an output high voltage (VOH) with a resistor 408. PMOS 306 may be multiple times smaller than a PMOS used in CTT but strong enough to pull up a signal sent from controller 108 to a receiver in memory device 110 such that the signal may ride on Vref1. Resistor 408 may be set at two to ten kilo ohms. A resistance on channel 410 may be high enough to allow for the Rpu and Rpd to set appropriate logic levels on the channel, but low enough to help with the VOH. Channel 410 may be unterminated as the weak pull-up may not be strong enough to compensate for termination. PMOS 408 may be enabled while memory device 110 is in CTT and may be disabled when storage device 104 and memory device are in LTT. As indicated above FIG. 4 is provided as an example. Other examples may differ from what is described in FIG. 4.

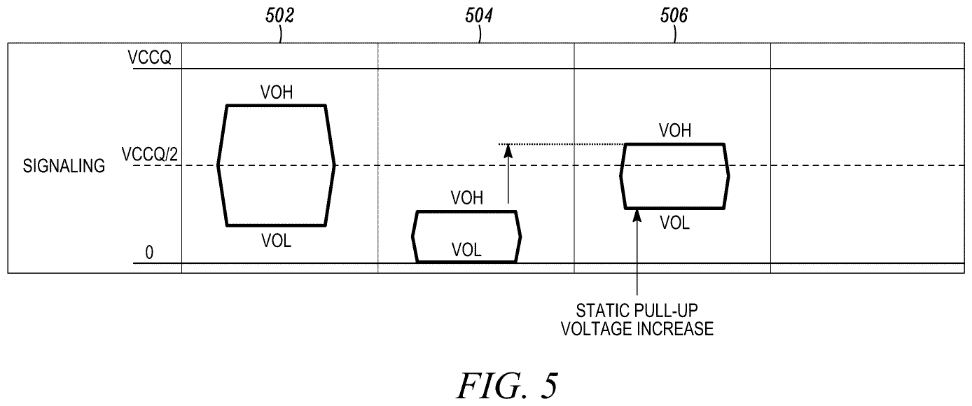

FIG. 5 is an example diagram showing how a driver in a storage device may cause the storage device to operate in CTT and LTT in accordance with some implementations. 502 shows signaling using, for example, driver 202, wherein a signal from controller 108 may ride on Vref1. 504 shows signaling using, for example, driver 210, wherein a signal from controller 108 may ride on Vref2. 506 shows signaling using, for example, drivers 302 or 402. A static pull-up, as shown in FIGS. 3 and 4 may help mimic CTT by increasing VOL so it is no longer truly low tapped. This may effectively push up the optimal reference point closer to CTT and may end up looking like a low-shifted reduced swing CTT since both VOH and VOL may be shifted higher, as shown in 506.

As an alternative to prevent VOL from being pulled up, the pull-up resistor may only be enabled when writing a logic ‘1’, However, a high resistance would take a long time to increase the VOH, so the resistance would have to be decreased to work dynamically and decreasing the resistance would increase the output capacitance, which is part of the advantage of LTT. Enabling the pull-up resistor only when writing a logic ‘1’ may increase the firmware complexity. For example, logic may be added to enable Rpu when the output is being driven to ‘1’. This may essentially be just adding another Rpu, at which point the configuration may be just an optional CTT driver. On the other hand, a static pullup, as shown in FIGS. 3 and 4 may allow for easier implementation while retaining the advantages of LTT. As indicated above FIG. 5 is provided as an example. Other examples may differ from what is described in FIG. 5.

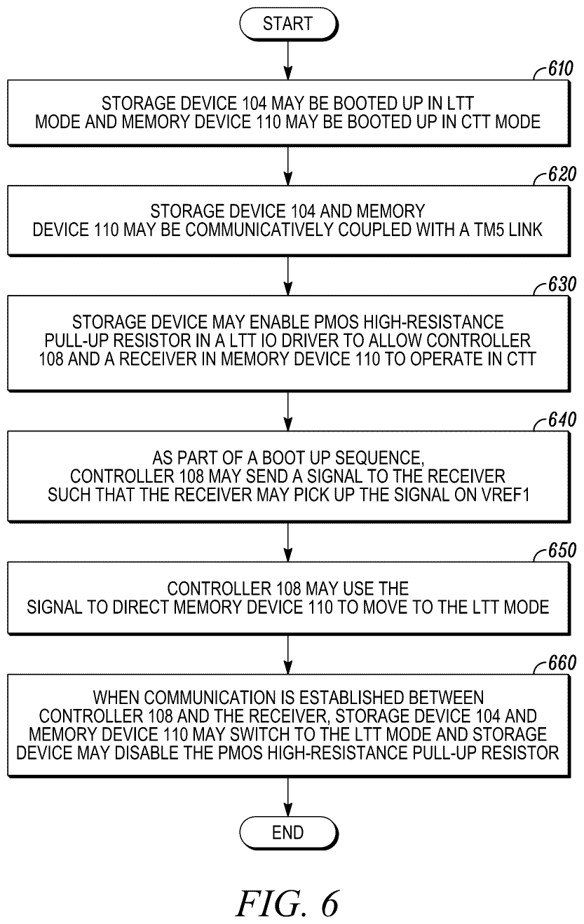

FIG. 6 is an example flow diagram for enabling a storage device which is booted up in LTT to communicate with a memory device which is booted up in CTT in accordance with some implementations. At 610, storage device 104 may be booted up in LTT mode and memory device 110 may be booted up in CTT mode. At 620, storage device 104 and memory device 110 may be communicatively coupled with a TM5 link. At 630, storage device may enable PMOS high-resistance pull-up resistor in a LTT IO driver to allow controller 108 and a receiver in memory device 110 to operate in CTT. At 640, as part of a boot up sequence, controller 108 may send a signal to the receiver such that the receiver may pick up the signal on Vref1. At 650, controller 108 may use the signal to direct memory device 110 to move to the LTT mode. At 660, when communication is established between controller 108 and the receiver, storage device 104 and memory device 110 may switch to the LTT mode and storage device may disable the PMOS high-resistance pull-up resistor. As indicated above FIG. 5 is provided as an example. Other examples may differ from what is described in FIG. 5.

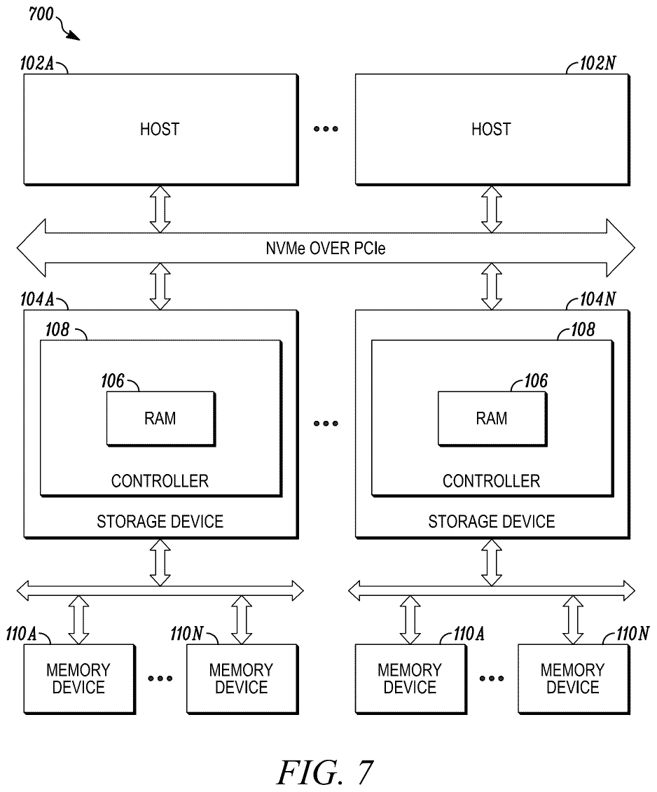

FIG. 7 is a diagram of an example environment in which systems and/or methods described herein are implemented. As shown in FIG. 7, Environment 700 may include hosts 102-102n (referred to herein as host(s) 102), and one or more storage devices 104a-104n (referred to herein as storage device(s) 104). Storage device 104 may include a controller 108 to enable a configurable PMOS to pull up an output high voltage when in CTT and to disable the configurable PMOS when in LTT.

Devices of Environment 700 may interconnect via wired connections, wireless connections, or a combination of wired and wireless connections. For example, the network in FIG. 7 may include NVMe over Fabric (NVMe-oF) Internet Small Computer Systems Interface (iSCSI), Fibre Channel (FC), Fibre Channel Over Ethernet (FCOE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of Environment 700 may perform one or more functions described as being performed by another set of devices of Environment 700.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to establish a connection with a receiver in a memory device that is booted up in a Center Tapped Termination (CTT) mode, the storage device comprises:
an access point to connect the storage device with a toggle mode (TM) link to communicatively couple the storage device to the memory device;
a Low Tapped Termination (LTT) input/output (IO) driver including a NMOS pull-up, a configurable PMOS pull-up to pull up an output high voltage (VOH), and an unterminated channel; and
a controller to enable the PMOS pull-up to cause the controller to operate in the CTT mode and communicate with the memory device booted in the CTT mode when the storage device is booted in the LTT mode, to cause the memory device to switch to the LTT mode and to communicate with the memory device in the LTT mode.

2. The storage device of claim 1, wherein the TM link is a fifth generation TM link that supports the CTT mode and the LTT mode.

3. The storage device of claim 1, wherein the NMOS pull-up creates a voltage (Vt) drop on a maximum VOH so that the VOH does not reach a supply voltage.

4. The storage device of claim 1, wherein resistance on the channel is high enough to allow for a pull-up resistor (Rpu) and a pull-down resistor (Rpd) to set appropriate logic levels on the channel, but low enough to help with the VOH.

5. The storage device of claim 1, wherein as part of a boot up sequence, the controller sends a signal to a receiver in the memory device on a CTT reference.

6. The storage device of claim 5, wherein the controller uses the signal to instruct the memory device to switch to the LTT mode.

7. The storage device of claim 1, wherein the controller disables the PMOS pull-up when the storage device and the memory device switch from the CTT mode to the LTT mode.

8. The storage device of claim 1, wherein the LTT driver is a one of a 37.5/75 ohms driver and a 50/100 ohms driver.

9. The storage device of claim 1, wherein the LTT driver includes an NMOS pull-up stack.

10. The storage device of claim 1, wherein the PMOS pull-up is a static pull-up to push an optimal reference point closer to a CTT reference point and to shift high and low output voltage levels higher.

11. A method in a storage device for establishing a connection with a receiver in a memory device that is booted up in a Center Tapped Termination (CTT) mode, the storage device comprises a controller to execute the method including:
booting up the storage device in a Low Tapped Termination (LTT) mode;
enabling a configurable PMOS pull-up in a LTT input/output (IO) driver to pull up an output high voltage (VOH);
sending a pulled-up signal to the memory device on a CTT reference;
directing the memory device to switch to a LTT mode;
switching to the LTT mode and disabling the PMOS pull-up; and
communicating with the memory device in the LTT mode.

12. The method of claim 11, further comprising connecting with the memory device using a fifth-generation toggle mode link that supports the CTT mode and the LTT mode.

13. The method of claim 11, further comprising using an NMOS pull-up in the LTT IO driver to create a voltage (Vt) drop on a maximum VOH so that the VOH does not reach a supply voltage.

14. The method of claim 11, further comprising using the PMOS pull-up as a static pull-up to push an optimal reference point closer to a CTT reference point and to shift high and low output voltage levels higher.

15. A storage device to establish a connection with a receiver in a memory device that is booted up in a Center Tapped Termination (CTT) mode, the storage device comprises:
an access point for connecting the storage device with a toggle mode (TM) link to communicatively couple the storage device to the memory device;
a Low Tapped Termination (LTT) input/output (IO) driver including a stack of NMOS, a configurable PMOS to pull up an output high voltage (VOH) with a resistor, and an unterminated channel; and
a controller to enable the PMOS high-resistance pull-up resistor to cause the controller to operate in the CTT mode and communicate with the memory device booted in the CTT mode when the storage device is booted in the LTT mode, to cause the memory device to switch to the LTT mode and to communicate with the memory device in the LTT mode.

16. The storage device of claim 15, wherein the TM link is a fifth generation TM link that supports the CTT mode and the LTT mode.

17. The storage device of claim 15, wherein the NMOS pull-up creates a voltage (Vt) drop on a maximum VOH so that the VOH does not reach a supply voltage.

18. The storage device of claim 15, wherein as part of a boot up sequence, the controller sends a signal to a receiver in the memory device on a CTT reference.

19. The storage device of claim 15, wherein the controller uses the signal to instruct the memory device to switch to the LTT mode.

20. The storage device of claim 15, wherein the controller disables the PMOS pull-up when the storage device and the memory device switch from the CTT mode to the LTT mode.
